(19) United States
(12) Patent Application Publication
(10) Pub. No.: US 2017/0234040 A1
(43) Pub. Date: Aug. 17, 2017

(54) Actuating Handle for a Motor Vehicle

(71) Applicant: Huf Hülsbeck & Fürst GmbH & Co. KG, Velbert (DE)

(72) Inventors: Markus Bartels, Muelheim (DE); Coen Dieker, Ratingen (DE); Dirk Mueller, Essen (DE); Stefan Moenig, Schwelm (DE)

(21) Appl. No.: 15/518,674

(22) PCT Filed: Aug. 20, 2015
(86) PCT No.: PCT/DE2015/100348

§ 371 Date: Apr. 12, 2017

(30) Foreign Application Priority Data
Oct. 13, 2014 (DE) 10 2014 114 799.5

(51) Int. Cl. E05B 85/10; G08B 5/36; E05B 85/06; B60R 25/01; B60Q 1/26

(52) U.S. Cl. CPC E05B 85/107; B60R 25/01; B60Q 1/2669; E05B 85/103; E05B 85/06; G08B 5/36

(57) ABSTRACT

Actuating handle (100) for a motor vehicle for opening and/or closing a door or a flap, comprising a grip element (101) which is designed for movement between an actuating position, in which the grip element (101) is arranged that can be actuated for manually opening a door or a flap (103), and a locking position, in which the grip element (101) is accommodated in a recess (105), wherein the grip element (101) comprises surrounding grip element delimiting sections (107) and the recess (105) has recess delimiting sections (109), wherein the actuating handle (100) is designed such that in the locking position of the grip element (101) each of the grip element delimiting sections (107) is arranged opposite a corresponding recess delimiting section (109), and wherein lighting means (201) are arranged at least in some regions on the grip element delimiting sections (107).

The present invention relates to an actuating handle for a motor vehicle for opening and/or closing a door or hatch according to the preamble to claim 1; the actuating handle has a grip element, which is embodied so that it is able to move between an actuating position in which the grip element can be actuated to manually open a door or hatch and a locking position in which the grip element is accommodated in a cavity; the grip element has surrounding grip element-delimiting sections and the cavity has cavity-delimiting sections; and the actuating handle is embodied so that in the locking position, each of the grip element-delimiting sections is positioned opposite a respective corresponding cavity-delimiting section.

In known devices for motor vehicles for opening and/or closing a door or hatch, an approach area or an area situated in front of the door or hatch is only insufficiently illuminated. Furthermore, the light source used for the illumination may become soiled, thus worsening the quality of the illumination.

The object underlying the invention is to propose an actuating handle for motor vehicles for opening and/or closing a door or hatch, which overcomes the problems known from the prior art, provides an improved illumination, and prevents soiling of the light source.

This object is attained by the subject with the features according to the independent claim. Advantageous embodiments of the invention are the subject of the figures, the description, and the dependent claims.

According to one aspect the invention, the object is attained by an actuating handle for a motor vehicle for opening and/or closing a door or hatch, having a grip element, which is embodied so that it is able to move between an actuating position in which the grip element can be actuated to manually open a door or hatch and a locking position in which the grip element is accommodated in a cavity; the grip element has surrounding grip element-delimiting sections and the cavity has cavity-delimiting sections; the actuating handle is embodied so that in the locking position, each of the grip element-delimiting sections is positioned opposite a respective corresponding cavity-delimiting section; and light sources are provided in at least some regions of the grip element-delimiting sections. For example, this achieves the technical advantage that an approach area illumination is improved and soiling the light sources is prevented. Moving the grip element and thus also the light sources into the actuating position enables an improved illumination of the approach area or the area situated in front of the door or hatch. In the locking position of the grip element, the light sources are also protected from soiling since the grip element and the light sources are accommodated in the cavity during driving operation. This prevents soiling and maintains the quality of illumination over the long term.

In an advantageous embodiment, the light source is embodied in the form of a continuous illumination strip; the illumination strip extends along the grip element-delimiting sections in a circumference direction of the grip element. For example, this achieves the advantage that the illumination can be provided uniformly in all directions.

In an advantageous embodiment, in the grip element-delimiting sections, the continuous illumination strip is positioned essentially in the middle in a depth direction and is covered in the locking position of the grip element. For example, this results in the advantage that particularly in the locking position, no light can escape to the outside. In addition, the illumination strip is protected from soiling and from mechanical influences.

In an advantageous embodiment, the light source is embodied to indicate an open or closed state of the door or hatch in the actuating position of the grip element. For example, this achieves the advantage of permitting a user to immediately determine the state of the door or hatch at first glance without having to perform a manual actuation of the grip element.

In an advantageous embodiment, the light source is embodied to indicate a battery charge state of a motor vehicle in the actuating position of the grip element. For example, this achieves the advantage of making the charge state of the motor vehicle immediately apparent, particularly in battery-operated electric vehicles.

In an advantageous embodiment, the grip element has an emergency actuation cavity. In addition, the actuating handle has a lock cylinder, which is covered by the grip element in the locking position. For example, this achieves the advantage that in the event of a malfunction or a discharged battery, the emergency actuation cavity can be moved manually, making the lock cylinder situated under the grip element accessible.

In an advantageous embodiment, the grip element can be moved from the locking position into the actuating position by actuating a remote control or activating a distance sensor. Alternatively or in addition, the grip element can be moved from the locking position into the actuating position by being driven around a pivot axis. For example, this achieves the advantage of providing a user with very convenient access to the door or hatch of the motor vehicle. Opening occurs automatically, and an optimal approach area illumination is implemented by means of the light source, even in darkness.

Exemplary embodiments of the invention are shown in the drawings and will be described in greater detail below.

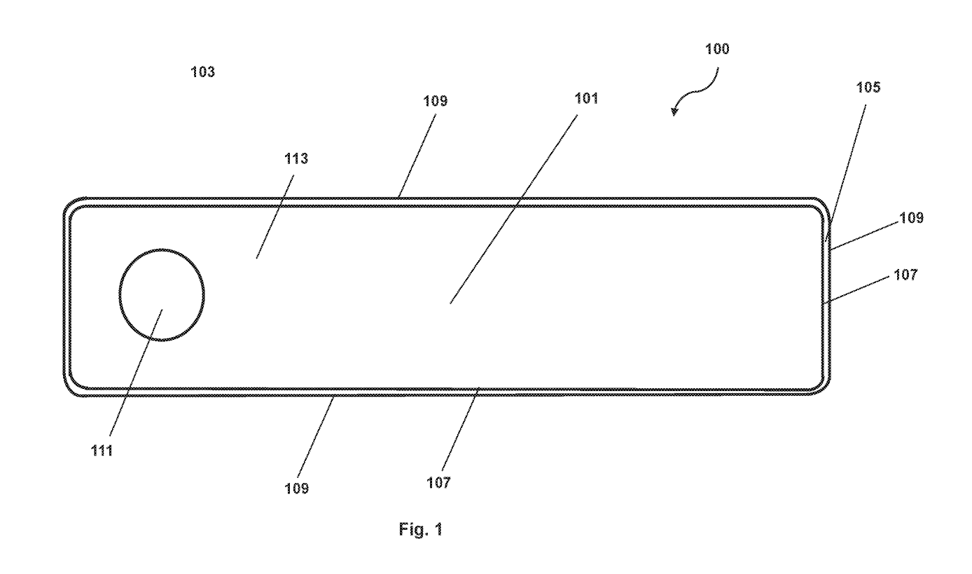

FIG. 1 is a schematic depiction of an actuating handle in the locking position, and

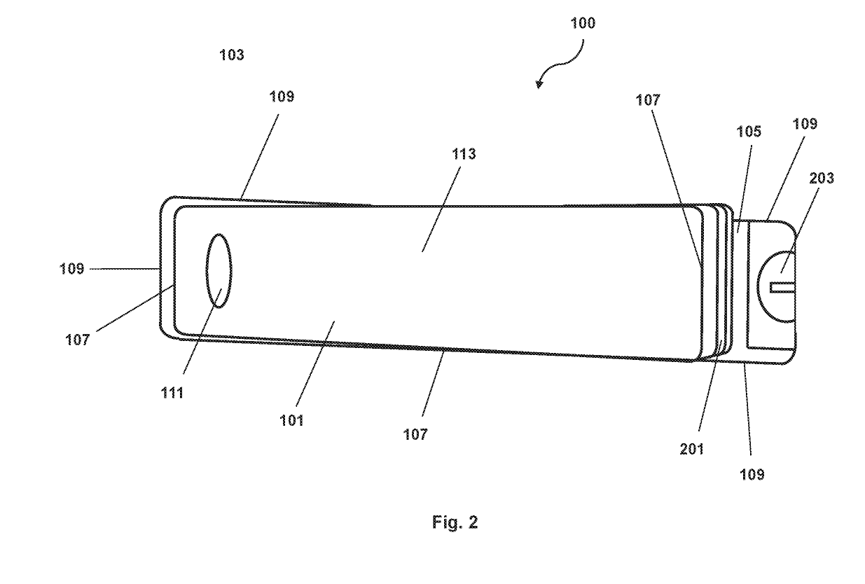

FIG. 2 is a schematic depiction of an actuating handle in the actuating position.

FIG. 1 is a schematic depiction of an actuating handle 100 for a motor vehicle for opening and/or closing a door or hatch 103 in the locking position. The grip element 101 has a rectangular basic shape and is accommodated in a rectangular cavity 105. The grip element 105 [sic] is accommodated in the cavity 105 in such a way that the grip element is flush with a door or hatch 103. The grip element 101 is delimited by surrounding grip element-delimiting sections 107, which, in the locking position or in the state in which the grip element 101 is accommodated in the cavity 105, are positioned opposite corresponding cavity-delimiting sections 109. Alternatively, the grip element 101 and the corresponding cavity 105 can have an oval or other shape. On an outer surface 113, the grip element 101 is provided with an emergency actuation cavity 111. By pressing the emergency actuation cavity 111, it is possible to mechanically move the grip element 101 from the locking position into the actuating position. This cavity is embodied as circular in the present embodiment, but it can also be embodied in any other conceivable shape.

FIG. 2 is a schematic depiction of an actuating handle 100 for a motor vehicle for opening and/or closing a door or hatch 103 in the actuating position. In the actuating position, the grip element 101 is positioned so that it can be actuated in order to manually open a door or hatch 103. In the embodiment shown, the grip element 101 is embodied so that it can be moved around a pivot axis from the locking position into the actuating position. This can be implemented, for example, with an electric drive, which can be actuated by tripping capacitive sensors on the outer surface 113 of the grip element 101, by actuating a remote control, or by activating a distance sensor. The grip element-delimiting sections 107 are provided with light sources 201 at least in some regions. In the present embodiment, the light source 201 is embodied as a continuous illumination strip; the illumination strip extends along the grip element-delimiting sections 107 in a circumference direction of the grip element 101. The continuous illumination strip can, for example, be embodied in the form of a multitude of LEDs or an alternative light source; the continuous illumination strip on the grip element-delimiting sections 107 is positioned essentially in the middle in a depth direction. Preferably, the central positioning of the continuous illumination strip can also be offset in a depth direction. This facilitates an improved protection of the light source in the locking position and less light can escape outward from the light source. Preferably, the light source 201 is embodied so that it is able to indicate an open or closed state of the door or hatch 103 when the grip element 101 is in the actuating position. For example, this can be implemented in order to illuminate the light source in different colors. In this connection, it would be conceivable to indicate an open state of the door or hatch by illuminating the light source in green, whereas a closed state of the door or hatch could be indicated by illuminating the light source in red. Alternatively or in addition, the light source 201 is embodied to indicate a battery charge state of a motor vehicle when the grip element 101 is in the actuating position. This is particularly important especially when using a battery-operated motor vehicle. The grip element 101 has the emergency actuation cavity 111 on an outer surface 113. In addition, the actuating handle 100 has a lock cylinder 203, which is covered by the grip element 101 in the locking position. Manual actuation of the emergency actuation cavity 111 uncovers the lock cylinder 203, permitting it to be manually actuated with a key. Alternatively or in addition, the actuating handle 100 cooperates with a remote control or a distance sensor. As a result, it is convenient for a user to use the actuating handle 100 since the grip element 101 is moved from the locking position into the actuating position through actuation of a remote control or through activation of a distance sensor. The movement of the grip element 101 from the locking position in to the actuating position is performed by a pivoting motion produced by a driving action around a pivot axis. Alternatively, however, the movement can also occur in translatory fashion; in this case, it would be necessary to find a suitable alternative solution with regard to the emergency actuation cavity.

The embodiment of the invention is not limited to the preferred exemplary embodiments indicated above. Instead, it is conceivable for there to be a number of variants that make use of the solution shown, even with fundamentally different embodiments. All of the features and/or advantages, including design details, spatial arrangements, and method steps that can be inferred from the claims, the description, or the drawings can be essential to the invention both in and of themselves and in a wide variety of combinations with one another.

1. An actuating handle for a motor vehicle for opening and/or closing a door or hatch, the actuating handle comprising:
a grip element operable between an actuating position in which the grip element can be actuated to manually open a door or hatch and a locking position in which the grip element is accommodated in a cavity, the grip element having surrounding grip element-delimiting sections and the cavity having cavity-delimiting sections with each of the grip element-delimiting sections being positioned opposite a respective corresponding cavity-delimiting section when the grip element is in the locking position; and
light sources disposed in at least some regions of the grip element-delimiting sections.

2. The actuating handle according to claim 1, wherein the light source is a continuous illumination strip that extends along the grip element-delimiting sections in a circumference direction of the grip element.

3. The actuating handle according to claim 2, wherein in the grip element-delimiting sections, the continuous illumination strip is positioned substantially in the middle in a depth direction.

4. The actuating handle according to claim 1, wherein the light source is covered in the locking position of the grip element.

5. The actuating handle according to claim 1, wherein the light source is operable to indicate an open or closed state of the door or hatch in the actuating position of the grip element.

6. The actuating handle according to claim 1, wherein the light source is operable to indicate a battery charge state of a motor vehicle in the actuating position of the grip element.

7. The actuating handle according to claim 1, wherein the grip element has an emergency actuation cavity.

8. The actuating handle according to claim 1, wherein the actuating handle has a lock cylinder, that is covered by the grip element in the locking position.

9. The actuating handle according to claim 1, wherein the grip element is operable to be moved from the locking position into the actuating position through actuation of a remote control or activation of a distance sensor.

10. The actuating handle according to claim 1, wherein the grip element is operable to be moved from the locking position into the actuating position by being driven around a pivot axis.
